(19) United States
(12) Patent Application Publication
(10) Pub. No.: US 2026/0261348 A1
(43) Pub. Date: Sep. 3, 2026

(54) A NOVEL METHOD FOR JOINT SENSING AND COMMUNICATION BY EXPLOITING ROUGH AND SMOOTH SURFACES AT MILLIMETER-WAVE AND TERAHERTZ FREQUENCIES

(71) Applicant: ISTANBUL MEDIPOL UNIVERSITESI, Istanbul (TR)

(72) Inventors: Saira RAFIQUE, Istanbul (TR); Muhammad Bilal JANJUA, Istanbul (TR); Hüseyin ARSLAN, Istanbul (TR)

(21) Appl. No.: 18/718,696

(22) PCT Filed: Dec. 7, 2022
(86) PCT No.: PCT/TR2022/051442

§ 371 Date: Jun. 11, 2024

(30) Foreign Application Priority Data
Dec. 14, 2021 (TR) 2021/019907

(51) Int. Cl. H04B 10/90; G01B 15/08

(52) U.S. Cl. CPC H04B 10/90; G01B 15/08

(57) ABSTRACT

Present invention relates to a new method for joint sensing and communication by exploiting diverse surfaces, such as rough and smooth surfaces, present in the environment.

### TECHNICAL FIELD

Present invention relates to a new method for joint sensing and communication by exploiting diverse surfaces, such as rough and smooth surfaces, present in the environment.

### PRIOR ART

At lower frequencies, the scattered signals resulting from the reflections of different scatterers in the environment effects the wireless communication performance at the receiver. However, these reflections or NLOS links have significant power at particular angular dimensions, hence they can be exploited to maintain additional links and can also assist in gaining insights about the environment (i.e., sensing). On the contrary, at high frequencies (mmwave and terahertz range) these NLOS links have low SNR; therefore, high carrier frequencies mostly support high-rate point to point LOS wireless links. However, when these high frequency signals encounter different surfaces in the environment; the scattering effects are unique to these surfaces. A smooth surface directs the incident beam/signal to its specular direction followed by the snell's law. However, a rough surface scatters the incoming signal to specular (i.e., coherent component) and non-specular direction (i.e., incoherent). The power of these coherent and incoherent components depend on the degree of roughness, the surface under observation possess.

At low frequencies, the interaction of transmitted signals with different scatterers in the environment produce reflected signals with significant power levels. These reflected NLOS signals can be exploited further to provide communication to users and for the localization of potential targets. However, these low frequency bands are unable to incorporate the increased data rate requirements and advanced wireless capabilities such as environment sensing which is required by next generation of wireless networks.

Therefore, higher carrier frequencies are being considered for advanced wireless communication. These high frequencies provide high capacity point to point and directional communication links but they are more susceptible to blockages caused by humans and other objects in the environment.

Moreover, these high frequencies offering abundant bandwidth are also limited by short communication ranges due to high path and reflection losses, intermittent availability of LOS paths and molecular absorption. Among these causes molecular absorption effect is more pronounced in the terahertz frequency range. To counter the effect of these attenuation losses, the power of the link is concentrated within a very narrow beam. Therefore, owing to the small footprint offered by higher frequencies, the beamforming gain is achieved through the generation of high power and narrow beams. Nevertheless, these pencil beams encounter the challenge of beam allignment, beam tracking and mobility management. They can be easily interrupted by a blockage, deep fade and minor beam misallignment caused due to movement of the potential user.

To overcome the effect of blockage at high frequencies steerable antennas are being deployed to establish a NLOS link towards the potential receiver. In a publication by Ma, Jaianjun et. Al, published in 2018, authors demostrated that an indoor surface can produce a reflected beam along the specular direction with significant power level at 200 GHz.

Another solution to deal with the issue of blockages at higher frequencies is through the deployment of intelligent reflecting surfaces. IRS is capable of dynamically modifying wireless channels to improve communication performance by smartly adjusting signal reflection using a large number of passive reflecting devices.

In a publication by Ma, Jianjun published in 2019, the authors discussed bistatic scattering properties of various metallic rough surfaces in the THz frequency range. It was demonstrated that when the direct LOS link is blocked, then an alternate NLOS link can be developed by exploiting specular reflection or diffused nonspecular scattering.

Overall, the solutions prosed in the state of the art can be listed as;
Tackling the effect of blockage at high frequencies through the use of steerable antennas to establish NLOS connection towards the mobile users.
Using a typical indoor surface (cinderblock painted wall) in an indoor environment to direct the transmitted signal towards its specular direction at 200 GHz.
Deploying intelligent reflected surfaces, where the passive reflectors smartly adjust the signal reflections towards the desired direction.
Exploiting diffused bistatic scattering properties of metallic rough surfaces for the establishment of NLOS links when the direct LOS path is unavailable due to the presence of blockage.

However, the solutions present in the state of the art also suffer from some advantages such as;
One of the prior art methods discusses the establishment of a link reflected from a typical indoor surface with significant power along the specular direction (angle of incidence=angle of reflection) at 200 GHz. However, because only specular reflection is considered such link is also considered as a NLOS link. A true NLOS link resulting from diffused scattering is not considered in this case.
Another prior art method solves the issue of blockage via IRS, however IRS-deployment faces the of challenges channel modelling, practical IRS beamforming design consideration and deployment costs.
Another prior art method exploits the diffuse bistatic scattering properties of metallic rough surfaces to establish NLOS communication links, however the use of these paths for sensing is overlooked.

### AIM OF THE INVENTION

Future generations of wireless communication systems support applications such as vehicle to vehicle (V2V) networks, vehicle to everything (V2X) communication, internet of things, geo-positioning (localization), etc that require both sensing and communication capabilities. Moreover, the sustainability of ubiquitous and reliable communication links also require prior knowledge about the environment where the mobile users/devices reside(rich, sparse scattering environment, the number of objects present between the transmitter and receiver). Hence, a sensing feedback is required for the seamless connectivity between the wireless users. Moroever, the sensed information about the objects in the environment can be used in diverse set of applications such as road safety, traffic surveillance and heath monitoring.

These benefits of joint sensing and communications can be reaped at the cost of increased bandwidth requirements. The bandwidth-hungry and revolutionary joint sensing and communication capabilities give rise to the issue of spectrum scarcity which further requires intelligent allocation and sharing of spectral and signalling resources among the coexisting sensing and communication systems. In the sub 6-GHz band, communication and sensing systems such as radars coexist together to support applications such as air traffic control, weather monitoring and military surveillance. Additionally, the mmWave band where the radar sensing systems reside is also being shared by communication systems since the deployment of 5G; which further aggravates the issue of spectrum congestion. Therefore, instead of merely sharing the spectrum between the two subsystems (communication and sensing), the joint design of communication and radar seems more advantageous and practical. Futhermore, moving towards increased data rate and high resolution sensing THz frequency is also being explored by academia and industry to actualize high-rate and high-resolution communication and sensing via integrated sensing and communication approaches.

As we move towards the higher frequencies, attenuation losses enhance and effect the performance of the communication link. To overcome these losses narrow beams are used. However, these narrow beams can be easily disrupted by blockages. Characterization of blockages are also needed for the establishment of uninterrupted communication links. Therefore sensing of the environment/obstacles can also be exploited to ensure seamless connectivity. In addition to that, the scattering effects of various surfaces in the environment are exploited for the actualization of sensing and communication

The inventors aim to provide a method that would counter the blockage problem at high frequencies, that would allow for NLOS link establishment at higher frquencies by exploiting rough surfaces, that would exploit the scattering properties of smooth anf rought surfaces ofr communication and sensing and that would be cost effective.

### BRIEF DESCRIPTION OF THE INVENTION

The invention relates to a method for joint sensing and communication via scattering properties of smooth and/or rough surfaces, in this method;

Reflection of the transmitted beams (120) by the smooth surfaces (130, 150) towards specular direction (160) wherein the angle of incidence is equal to the angle of reflection takes place.

The power of received beam along this coherent direction is proportional to the transmitted power.

The communication links along the coherent reflected component (160) of the scattering surface is established.

The transmitted beams (120) are reflected by the rough surfaces (140) wherein the incident beam scatters into both coherent and incoherent reflected components (170), herein the power of the coherent and incoherent reflected components depend on the roughness of the surface

If the roughness of the surface increases incoherent component dominates in all directions and the coherent component becomes negligible.

The received beam strength can also be used to characterize the roughness of the surface,

At higher frequencies such as mmwave and THz range the wavelength is of the order of surface irregularities, therefore Fraunhofer criterion is also used to identify whether the surface is smooth or not.

According to this criterion, a surface is considered as a smooth surface if the phase difference between two reflected rays from different points of the same surface is less than π/8.

At a surface with intermediate roughness, both coherent and incoherent components of the scattered beam have significant amount of incident power. In case where a sensing/radar target 190 is located towards the incoherent reflected component of the beam, then that reflected component of the incident beam is used for the sensing of the target.

Through the detailed analysis of the recieved beams, their respective powers and phase difference between multiple beams coming from the same surface, the roughness and smoothness of the surface under consideration can also be characterized.

Overall, scattering properties of smooth and rough surfaces are exploited for the implementation of a joint sensing and communication system. Particularly, the scattering pattern of an incident signal on a rough surace is analyzed and exploited for localization/sensing of a target along the incoherent angular dimension.

The proposed method for the realization of joint sensing and communication in the mmWave and terahertz frequencies exploits the scattering properties of various surfaces in the environment. Unlike previous works, not only the coherent but also the incoherent component of the reflected beam is analyzed and exploited for integrated sensing and communication.

The proposed method also solves the critical issue of blockage at high frequencies without the deployment of intelligent reflecting surfaces; rather it uses the available environmental resources to not only solve the blockage issue but also to use the surfaces' scattering properties for sensing and communication. In addition to that, the angles and power of the received beams can also be used to characterize the roughness/smoothness of the surface that forward scatters the transmitted beams towards the receiver.

An embodiment of the invention relates to a method for joint sensing and communication via scattering properties of smooth and/or rough surfaces, wherein said method comprises the steps of:
The multi-antenna transmitter, transmits multiple beams towards rough and smooth surfaces in the environment.
The smooth surface reflects a high power beam towards the specular direction.
This high power, reflected coherent beam is used to provide communication to the mobile receiver located at the direction of reflection.
The rough surface, decomposes the incident beam into coherent and incoherent components.
The coherent component of the decomposed reflected beam is used to provide communication to the mobile receiver.
The incoherent component of the decomposed reflected beam is used for sensing of the target located towards the non-specular direction of reflection.

### EXPLANATION OF FIGURES

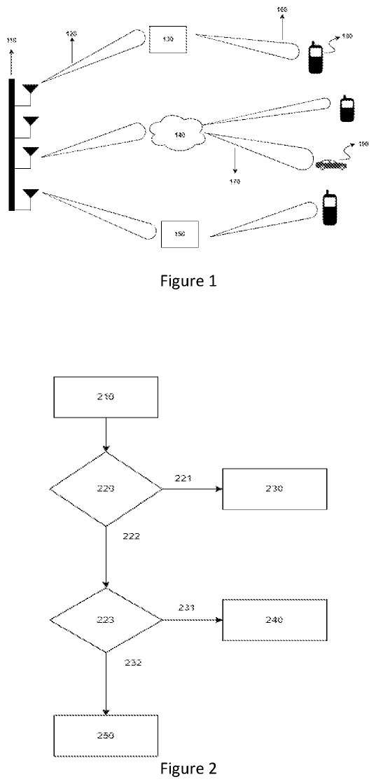

FIG. 1: the process of the proposed invention actualizing joint sensing and communication via scattering properties of smooth and rough surfaces
110: transmitter
120: transmitted beams
130: smooth surface
140: rough surface
150: smooth surface
160: specular direction
170: scattered incoherent reflected component
180: communication receiver
190: sensing/radar target

FIG. 2: The flow chart illustrating joint sensing and communication at higher frequencies via rough surfaces
210: In this step the beams are directed towards different surfaces present in the environment
220: In this step it is decided whether the surface is smooth or not
221: In this step the surface is smooth
222: In this step the surface is not smooth
223: In this step, it is checked whether or not the received beam component is coherent or not
230: In this step, coherent component is received
231: In this step, coherent reflected component is received
232: In this step, the received reflected beam component is not coherent
240: In this step, coherent reflected component is used for communication
250: In this step, the received incoherent beam is used for sensing

### DETAILED DESCRIPTION OF THE INVENTION

In one aspect present invention relates to a method for joint sensing and communication at higher frequencies via rough surfaces wherein said method comprises of the steps;
Directing the transmitted beams towards different surfaces present in the environment (210),
Initially, beam training is performed. During this process multiple narrow beams are transmitted from the transmitter. The receiver receives these beams and based on the power and angular spread of the received beams, it is decided whether the reflected beam is smooth or rough. A smooth surface produces a strong coherent reflection at the receiver where angle of incidence (between the transmitted beam and the smooth surface) is equal to the angle of reflection. This angle information is fed back to the transmitter and in the next iteration, the transmitted beam is directed towards that particular angular dimension. On the contrary, a rough surface produces two reflected beam components at the receiver, one of the components is received at an angle equivalent to the angle of incidence (specular component), whereas the other reflected component is received along the non-specular direction. The power of the specular component received from the rough surface is less than that reflected from the smooth surface. The rougher a surface is, more power is distributed into the non-specular direction. From the power of the reflected components and angular spread along the specular and non-specular direction it is determined that the reflected components are coming from a rough surface. The angular spread of the rough surface is also fed back to the transmitter and consequently, in the next iteration the transmitted beam is directed towards the rough surface to incorporate the sensing target located along the non-specular direction of reflection.
Deciding whether the surface is smooth or not (rough) (220)
The roughness of the surfarce can be measured via Rayleigh roughness criteria which depends on the power of the coherent component. The more rough the surface is, the weaker (less power) is the coherent component of the received beam. Hence, the received beam strength is used to decide whether a surface is rough or smooth. At higher frequencies such as mmwave and THz range the wavelength is of the order of surface irregularities, therefore Fraunhofer criterion is also used to identify whether the surface is smooth or not (Ulaby, Fawwaz Tayssir. “Microwave remote sensing active and passive.” Rader remote sensing and surface scattering and emission theory (1982): 848-902). According to this criterion, a surface is considered as a smooth surface if the phase difference between two reflected rays from different points of the same surface is less than π/8.
If the surface is smooth (221), coherent component is received (230)
If the surface is not smooth (i.e., rough surface) (222), check whether the received beam component is coherent or not (223),
When the angle of reflection of the received beam is equal to the angle of incidence of the transmitted beam, then that component is considered as the coherent component of the received beam. Here, the angle of incidence is between the transmitted beam and the surface and angle of reflection is the angle between the reflected beam and the surface under consideration.
If the coherent reflected component is received (231) use it for communication (240),
The communication receiver which is located at a particular angular dimension is aimed to be provided with a high power and consistent communication signal. The angular location of the receiver is assumed to be along the coherent component of the reflected signal. Since smooth surfaces produce strong coherent component so they are used to provide communication signal to the receiver. Moreover, a specific rough surface that produce coherent component with significant power level is also used to provide communication link to the receiver. If the incoherent reflected component is received (232) use it for sensing (250).
A rough surface which produces coherent and incoherent components with significant power levels are exploited for joint sensing and communication functionality. The power and angular spread of the incoherent or diffused scattered reflection is used for sensing of the target.

### EXAMPLES

### Example 1

### Process According to the Present Invention Performing Joint Sensing and Communication Via Scattering Properties of Smooth and Rough Surfaces

FIG. 1 illustrates the process of the proposed invention actualizing joint sensing and communication via scattering properties of smooth and rough surfaces. The transmitter 110 consists of multiple antennas transmitting mutiple beams via digital beamforming. These transmitted beams 120 encounter various surfaces present in the environment. The smooth surfaces 130 and 150 reflect the incident beams towards specular direction 160 where angle of incidence is equal to the angle of reflection. The power of received beam along this coherent direction is proportional to the transmitted power and hence this strong and reliable connection is used for communication users 180 in the proposed method. Throughout the figure communication links are established along the coherent reflected component 160 of the scattering surface. However, when the transmitted beam strikes the rough surface 140, the incident beam scatters into both coherent and incoherent reflected components 170. The power of the coherent and incoherent reflected components depends on the roughness of the surface. When the roughness of the surface is increased, then the incoherent component dominates in all directions and the coherent component becomes negligible. The roughness of the surfarce can be measured via Rayleigh roughness criteria which depends on the power of the coherent component. The more rough the surface is, the weaker is the coherent component of the received beam. Hence, the received beam strength can also be used to characterize the roughness of the surface. At higher frequencies such as mmwave and THz range the wavelength is of the order of surface irregularities, therefore Fraunhofer criterion is also used to identify whether the surface is smooth or not (Ulaby, Fawwaz Tayssir. “Microwave remote sensing active and passive.” Rader remote sensing and surface scattering and emission theory (1982): 848-902). According to this criterion, a surface is considered as a smooth surface if the phase difference between two reflected rays from different points of the same surface is less than π/8. At a surface with intermediate roughness, both coherent and incoherent components of the scattered beam have significant amount of incident power. In case where a sensing/radar target 190 is located towards the incoherent reflected component of the beam, then that reflected component of the incident beam is used for the sensing of the target.

Through the detailed analysis of the recieved beams, their respective powers and phase difference between multiple beams coming from the same surface, the roughness and smoothness of the surface under consideration can also be characterized.

### Industrial Applicability of the Invention

This invention is a method directed to joint sensing and communication at mmWave and terahertz frequency range by exploiting the scattering properties of various surfaces present in the environment.

The sensing and localization of a particular target is acheived via incoherent reflected component produced by a rough surface. The reflected beam from a particular surface is also dependent on the angle of incidence and transmtted power.

With emerging wireless standards of 3GPP and IEEE organizations such as 5G and IEEE 802.11bf, the sensing requirement becomes significantly important, particularly for emerging applications such as autonomous vehicles, virtual reality, autonomous robots, indoor positoning etc. The proposed invention provides a cost effective method for joint sensing and communication at higher frequencies via exploitation of scattering properties of various rough surfaces in the environment.

The method of the invention does not require any additional hardware complexity and therefore this invention will be very fruitful for future industrial applications requiring integrated sensing and communication functionality.

This invention has a potential in the industrial applications requiring the sensing and communication especially for vehicle to everything, Internet-of-everything, and geo-positioning.

Around these basic concepts, it is possible to develop several embodiments regarding the subject matter of the invention; therefore, the invention cannot be limited to the examples disclosed herein, and the invention is essentially as defined in the claims. Separate embodiments of the invention can be combined where appropriate.

It is obvious that a person skilled in the art can convey the novelty of the invention using similar embodiments and/or that such embodiments can be applied to other fields similar to those used in the related art. Therefore, it is also obvious that these kinds of embodiments are void of the novelty criteria and the criteria of exceeding the known state of the art.

1. A method for joint sensing and communication at high frequencies via rough and smooth surfaces, the method comprising:
directing transmitted beams towards different surfaces present in the environment (210);
deciding whether the surface is smooth or not (220);
if the surface is smooth (221), a strong coherent component is received (230);
if the surface is not smooth (i.e., rough surface) (222), check whether the received beam component is coherent or not (223);
if the coherent reflected component is received (231) use it for communication (240); and
if the incoherent reflected component is received (232) use it for sensing (250).

2. The method of claim 1, comprising the steps of:
providing a multi-antenna transmitter that transmits multiple beams towards rough and smooth surfaces in the environment (210);
the smooth surface reflects a high power beam towards the specular direction (230);
this high power, reflected coherent beam is used to provide communication to the mobile receiver located at the direction of reflection (240);
the rough surface decomposes the incident beam into coherent and incoherent components (223);
the coherent component of the decomposed reflected beam is used to provide communication to the mobile receiver (240); and
the incoherent component of the decomposed reflected beam is used for sensing of the target located towards the non-specular direction of reflection (250).
